(19) United States
(12) Patent Application Publication
(10) Pub. No.: US 2017/0251652 A1
(43) Pub. Date: Sep. 7, 2017

(54) PLANER BOARD RELEASE DEVICE

(71) Applicant: Albert J. Novak, Allison Park, PA (US)

(72) Inventor: Albert J. Novak, Allison Park, PA (US)

(21) Appl. No.: 15/452,643

(22) Filed: Mar. 7, 2017

Related U.S. Application Data
(60) Provisional application No. 62/304,746, filed on Mar. 7, 2016.

(51) Int. Cl. A01K 91/053; A01K 91/08; F16B 45/02; A01K 99/00

(52) U.S. Cl. CPC A01K 91/053; A01K 99/00; A01K 91/08; F16B 45/02

(57) ABSTRACT

Disclosed herein is a device comprising a body having a first opening and a second opening. A clip is attached to the first end of the body and the second opening is adapted to receive a cord, such as a rubber band. The cord can be attached to a fishing line and the clip is attached to an outrigger line, which is typically used with a planer board. When a fish is engaged on an end of the fishing line, the force causes the cord to break, freeing the fishing line from the trolling line. The shape and color of the body provide visibility to the fisherman in the boat.

### CROSS-REFERENCE TO RELATED APPLICATIONS

This application claims the benefit under 35 U.S.C. §119 of Provisional Application Ser. No. 62/304,746, filed Mar. 7, 2016, which is incorporated herein by reference.

### STATEMENT REGARDING FEDERALLY SPONSORED RESEARCH

Not applicable.

### BACKGROUND OF THE INVENTION

The invention relates generally to equipment used for fishing. More specifically, the invention relates to a device used to connect a fishing line to an outrigger line used when trolling.

Fishermen often employ subsurface trolling techniques when fishing for certain species of fish. To accommodate multiple fishing lines without tangling when trolling, individual fishing lines can be spaced apart along a length of outrigger line extending from the boat. A planer board attached to an end of the outrigger line is drawn out and away from the side of the boat as it is trolled through the water, thereby extending the trolling line. In this configuration, a fishing line extends from a rod inside the boat, to a point on the outrigger line, then into the water and behind the boat.

To attach the fishing line to the outrigger line, a planer board release device is often used. The device provides the fisherman with the ability to selectively space the distance between lines on the outrigger line, thus preventing line tangling. In addition, the release device provides a convenient way to detach the fishing line from the outrigger line when reeling-in a fish.

Some fisherman use home-made release devices such as shower curtain clips and clothes pins. With a clothes pin, one end is attached to the trolling line and the jaws of the clothes pin clamp the fishing line. However, these devices often suffer from being unable to provide the proper release tension for the species being fished. For example, the clamping force of the clip or clothes pin holding the fishing line should be sufficient to prevent detachment from line tension experienced during normal trolling movements, but should not be too excessive as to prevent detachment when a fish is hooked. With purpose-built devices, a fisherman can choose a release device with the proper clamping force for the species being fished and, often, a variety of devices with differing clamping forces are available. A drawback with clamp-type devices is that the spring mechanism providing the clamping force can become corroded, making operation difficult and adversely affecting the clamping force. Further, the fisherman may need several different devices of varying tension in any one fishing trip.

To overcome these problems, several release devices use a cord or loop of cord (such as a rubber band) to connect the fishing line to the release device. When sufficient tension is placed on the fishing line by a hooked fish, the cord breaks, freeing the fishing line from the release device. While these devices can be used with different breaking strength cord, the cord or rubber band can be difficult to set, such as when when fishing in cold weather and gloves are used.

In addition, many of these devices are difficult to see on the trolling line, which can extend for many yards beyond the side of the boat. A visual indication is useful to avoid crossing lines. For example, once a fishing line is attached to the release device, the fisherman releases fishing line from the reel until the release device moves to the proper position on the trolling line. This task becomes difficult without a clear visual indication of the line's position.

It would therefore be advantageous to develop a planer board release device that provides consistent release tensions, ease of use, and high visibility.

### BRIEF SUMMARY

According to embodiments of the present invention is a planer board release device comprising a body having an opening for a cord at one end and an opening for an attachment device at a second end. The attachment device can be a carabiner, a steel ring, similar devices, or a combination of devices, according to various embodiments. The opening for the cord is shaped to allow easy attachment of the cord to the body, but prevents unintended release of the cord. Further, the color of the body can be varied to provide high visibility to the fisherman in the boat.

### BRIEF DESCRIPTION OF THE SEVERAL VIEWS OF THE DRAWINGS

FIG. 1 shows the body of the planer board release device, according to one embodiment.

FIG. 2 shows an example embodiment of the planer board release device.

### DETAILED DESCRIPTION

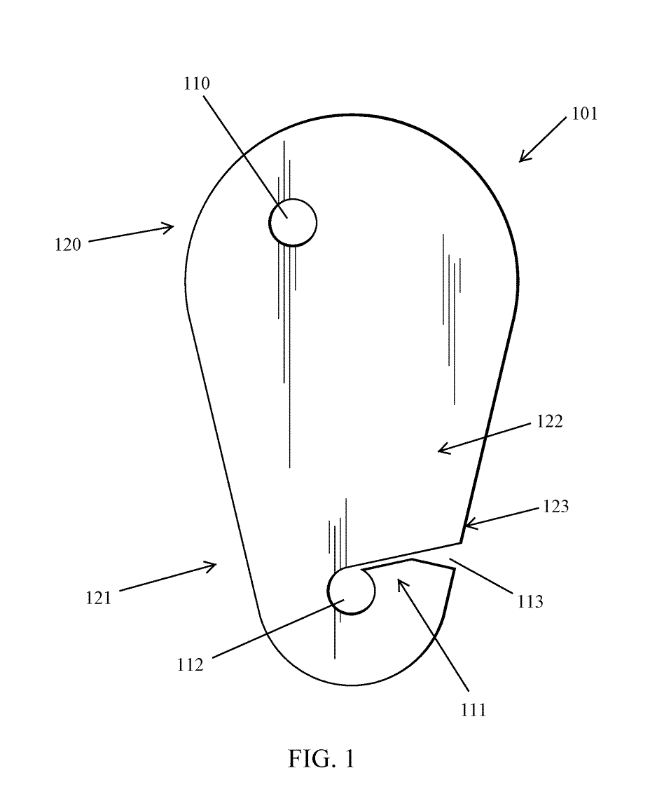

According to one embodiment of the present invention is a planer board release device 100 comprising a body 101, an attachment mechanism 105 attached to a first opening 110 at one end 120 of the body 101, and a second opening 111 on the opposite end 121 of the body 101, where the second opening 111 is adapted to receive a cord 104 or loop of cord 104. As shown in FIG. 1, the body 101 is substantially planar and oblong with the first opening 110 and second opening 111 disposed on the planar surface of the body 101. In alternative embodiments, the shape of the body 101 can vary. As further shown in FIG. 1, the first opening 110 is fully enclosed (i.e. surrounded by the material of the body) at an interior portion 122 of the body 101 and is generally circular shape. In alternative embodiments, the first opening 110 can have any shape that accepts the attachment mechanism 105.

The body 101 of the release device 100 can be constructed from a variety of materials, including plastics, wood, or metal. In one embodiment, the body 101 is constructed of acrylic having a high visibility color. Alternatively, the body 101 can be provided with a high visibility paint or coating. Providing a high visibility color allows the fisherman to locate the device along the trolling line. With greater visibility, the fisherman will also have an easier time determining when the fishing line has been released since the device 100 tends to slide down the trolling line when the fishing line is no longer attached. To further aid visibility, the body 101 of the device 100 is sufficiently large enough to be viewed from the boat. The size can vary depending on the environmental conditions and the length of the trolling line.

Referring again to FIG. 1, the second opening 111 is positioned on an end 121 of the body 101 opposite the first opening 110 and is adapted to receive the cord 104. More specifically, the second opening 111 is defined by an aperture 112 sized to hold the cord 104 during trolling operations. Like the first opening 110, the aperture 112 is also located at an interior portion 122 of the body 101. The second opening 111 is further defined by a slit 113 that extends from the aperture 112 to a perimeter 123 of the body 101. As shown in FIG. 1, the slit 113 is generally wider at the perimeter and tapers, becoming narrower at the aperture 112. The shape of the slit 113 allows easy insertion of the cord 104 into aperture 112, but prevents the cord 104 from inadvertently sliding out of the second opening 111. For example, in one embodiment a rubber band is used as the cord 104 and the width of the slit 113 is slightly larger than the narrower width of the rubber band 104. Thus, the rubber band 104 can only be inserted or removed in one particular orientation, greatly reducing the chance of the rubber band 104 sliding out of the second opening 111. By way of further example, the greater width of the slit 113 at the perimeter 123 would allow a fisherman to loop a rubber band (i.e. cord 104) over the body 101 and slide it down the edge until catching in the slit 113.

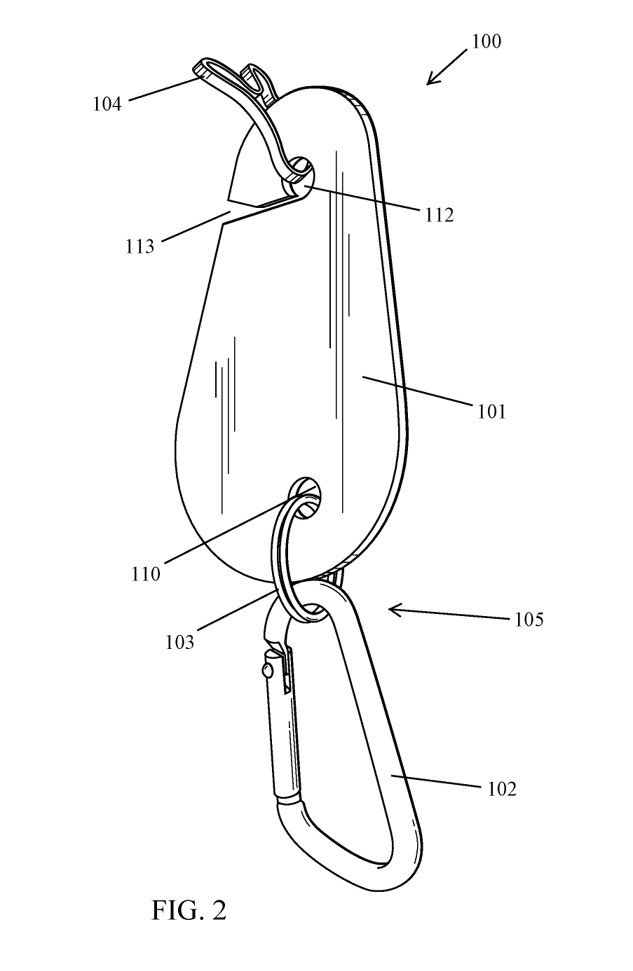

FIG. 2 shows a rubber band as the cord 104 disposed within the second opening 111. In operation, the cord 104 is further attached to the fishing line and is expected to break when a hooked fish increases the tension on the fishing line. The breaking strength of the cord 104 can be chosen depending on the species being fished. For example, if small fish are being caught, a cord 104 with a lower breaking force should be used. In contrast, a cord 104 with a higher breaking force should be used if fishing for larger game fish. While a rubber is used as the cord 104 material in the example embodiment shown in FIG. 2, synthetic, natural, or polymer materials can also be used for the cord 104. In addition, the cord 104 can be in the shape of a loop, like the rubber band, or it can be a non-continuous string. When a string 104 is used, a knot can be tied on one end of the string 104 that is larger than the aperture 112 to prevent the string 104 from releasing from the device 100. The second end of the string 104 can then be tied to the fishing line.

Referring again to embodiment shown in FIG. 2, a ring 103 and clip 102 are used in combination as the attachment mechanism 105. In this embodiment, the ring 103 is affixed to the body 101 through the first opening 110, which in turn is attached to the clip 102, which is adapted to attach to the trolling line. The clip 102 shown in FIG. 2 is a carabiner, allowing the planer board release 100 to be easily attached or detached from the trolling line via the spring-loaded gate of the carabiner. A person having skill in the art will appreciate that any type of clip, shackle, hook, ring, or any combination of these devices, can be used as the attachment mechanism 105. In the example embodiment shown in FIG. 2, the clip 102 is indirectly attached to the body 101 of the release device 100 via the ring 103 in order to permit movement between the body 101 and the clip 102, which can be advantageous in rough waters where the planer board and trolling line are moving with the waves.

In operation, a fisherman will attach the release mechanism 100 to the trolling line using the attachment mechanism 105. Next, the fisherman will release an amount of line from the reel, corresponding to the length of line that will extend from the trolling line and into the water. With this length determined, the fisherman will attach the cord 104 to the fishing line. In the embodiment where a rubber band is used at the cord 104, a half hitch knot could be used to tie the rubber band to the fishing line. The cord 104 is then slid through slit 113 to rest in aperture 112 of the second opening 111. As the fisherman spools out additioal fishing line, the release device 100 will slide down the outrigger line. The fisherman stops the fishing line from spooling off the reel when the device 100 reaches the desired position. If a cord 104 with the correct breaking tension is used, the cord 104 will break when a fish is hooked, disengaging the fishing line from the release mechanism 100. Once disengaged, the fisherman can reel-in the hooked fish.

While the disclosure has been described in detail and with reference to specific embodiments thereof, it will be apparent to one skilled in the art that various changes and modification can be made therein without departing from the spirit and scope of the embodiments. Thus, it is intended that the present disclosure cover the modifications and variations of this disclosure provided they come within the scope of the appended claims and their equivalents.

What is claimed is:

1. A planer board release device to attach a fishing line to a trolling line comprising:
a body having a first opening and a second opening
wherein the second opening is adapted to receive a cord,
wherein the first opening is located at a first end of the body and the second opening is located at a second end of the body; and
an attachment mechanism affixed to the body through the first opening.

2. The device of claim 1, further comprising:
a cord disposed within the second opening.

3. The device of claim 2, wherein the cord is a rubber band.

4. The device of claim 1, wherein the attachment mechanism comprises:
a ring disposed in the first opening, and
a clip attached to the ring.

5. The device of claim 4, wherein the clip is a carabiner.

6. The device of claim 1, wherein the second opening comprises:
an aperture disposed within an interior portion of the body, and
a slit extending from the aperture to a perimeter of the body.

7. The device of claim 6, wherein the slit is tapered, having a greater width at the perimeter.

8. The device of claim 1, wherein the body is constructed from a high visibility material.

9. The device of claim 1, wherein the body is coated with a high visibility material.

10. The device of claim 2, wherein the cord is attached to a fishing line.

11. The device of claim 1, wherein the body is oblong.

12. The device of claim 1, wherein the body is substantially planar.
